(19) United States
(12) Patent Application Publication
(10) Pub. No.: US 2006/0264559 A1
(43) Pub. Date: Nov. 23, 2006

(54) Gel composition for optical fiber cable

(76) Inventors: Saurabh S. Lawate, Concord, OH (US); Robert Silverstein, Great Neck, NJ (US)

Correspondence Address: THE LUBRIZOL CORPORATION;ATTN: DOCKET CLERK, PATENT DEPT., 29400 LAKELAND BLVD., WICKLIFFE, OH, 44092, US

(21) Appl. No.: 10/544,276

(22) PCT Filed: Feb. 4, 2004
(86) PCT No.: PCT/US04/03572

§ 371 Date: Aug. 7, 2006

Related U.S. Application Data
(60) Provisional application No. 60/445,607, filed on Feb. 7, 2003.

(51) Int. Cl. C08K 3/34

(52) U.S. Cl. 524/492

(57) ABSTRACT

A gel composition from a synthetic lubricating oil, fumed silica, an antioxidant and a coupling agent for the fumed silica is described.

### FIELD OF INVENTION

Composition of optical fiber gels having compatibility with polymeric sheathings commonly used in optical fiber cables. The gels in filled cables minimize the intrusion of water and other harmful compounds into filled information transmission cables such as optical fiber cables. The gels along with the cable sheath protect the internal wires, fibers etc. from stresses applied to the cables sheath during manufacturing, installation and use.

### BACKGROUND OF THE INVENTION

The optical fiber cable industry manufactures optical fiber cables by encasing the optical fibers in a polymeric sheathing. A jelly is placed between the polymeric sheathing and the optical fiber. The purpose of this jelly is to provide water resistance and as a buffer to bending stresses and strains.

Typical sheathing materials are polymeric in nature with polypropylene (PP) and polybutylterepthalate (PBT) being the most commonly used sheathing materials.

The jelly is usually a non-Newtonian oil. The non-Newtonian nature allows the jelly to thin out during processing and set after the processing shear forces are removed. Critical parameters that impart the necessary performance are viscosity at various shear rates and the yield stress. Typically the jelly is made using oil and an inorganic or organic thickener. Inorganic thickeners used range from organic clays to silica. These thickeners are suspended in a hydrophobic oil such as a mineral oil or synthetic oil. Additionally, stabilizers may be incorporated to ensure oxidative stability of the mixture.

The oil chosen has a profound influence on the compatibility of the jelly with the sheathing material. Typically, mineral oil based jellies are compatible with PBT sheathing whereas synthetic hydrocarbon oil based jellies are compatible with PP sheathing materials. Synthetic jellies are more expensive than mineral oil based jellies and there is a need for cheaper jellies that will be compatible with PP sheathings. Moreover, there is a need for a cheaper jelly that would be compatible with both PP and PBT sheathings i.e. a ‘universal product’.

Very few examples exist in prior art which identify jelly compositions that are compatible with both sheathing materials. As an example U.S. Pat. No. 5,672,640 outlines the use of castor oil and a ricinoleate polyol with colloidal particles. U.S. Pat. No. 5,672,640 also highlights the critical problem that expensive components have to be used in order for the jelly to be compatible with PP sheathing materials. U.S. Pat. No. 5,672,640 clearly outlines the need for low cost cable filling compounds that are compatible with PP and provides a solution for the problem via the use of castor oil derivatives. Unfortunately, to be useful there is a need for high loading of silica in these formulations which adds cost.

U.S. Pat. No. 4,701,016 outlines the use of various mineral and synthetic base oils but the drawback is that it uses very high loadings of silica. This can add to cost very significantly.

U.S. Pat. No. 5,905,833 discusses the use of a jelly composition containing mineral oils and a thickening system. The thickening system contains silica's and a polymer. High molecular weight polymers are used. The primary drawback of this is that the polymer itself is expensive and requires very long processing times in order to solubilize it into the base oil used. It is thus desirable to eliminate the use of such polymers.

### SUMMARY OF THE INVENTION

The present application solves the problem of non-compatibility with polypropylene of certain filling compositions widely used in the industry without sacrificing desired performance or increasing cost. The use of a blend of polydecene and polybutene in ratios as outlined in the preferred embodiments of the present invention enables that the jelly is compatible with PP and PBT without sacrificing low temperature performance. Also disclosed are optimized compositions for gels for fiber optic cables derived from oil, colloidal silica filler, an optional high molecular weight polymer and optional functional additives. Gel compositions were developed based on the blend of polydecene and polybutene basestocks and thickeners, which are compatible with the PP and PBT sheathings (e.g. they do not soften or deteriorate the sheath material).

Further, the preferred formulations have eliminated the use of very high loadings of silica as outlined in U.S. Pat. No. 4,701,016 or the use of high molecular weight polymers as in U.S. Pat. No. 5,905,833. This has been accomplished using a higher surface area silica gel and a polyglycol coupling agent. Use of this combination enables the use of lower loadings of silica without the use of polymeric thickeners.

Other objects and advantages of the present invention will become apparent to those skilled in the art from the following detailed description read in conjunction with the claims appended hereto

### DETAILED DESCRIPTION

The gel composition generally comprises a base oil, a colloidal silica, and optionally a high molecular weight polymer, or coupling agents and antioxidants.

Base Oil

The base oil can be any of the American Petroleum Institute's (API) Group IV, or Group V basestock. Typical Group IV base oils include PAOs, while Group V basestocks include synthetic esters, vegetable oils, polyglycols, polydecenes, and polybutenes. Specific examples of this type of component include polyalpha olefin (PAO) and other synthetic oils such as polyglycol and polybutene. The amounts of base oil in the compositions of the present invention are generally from about 80 to about 97 weight percent and more desirably from about 86 to about 96 based on the weight of the composition.

Colloidal Particulate

Colloidal hydrophobic and hydrophilic silica used individually or in combination. In some embodiments the hydrophilic silica is preferred. In some embodiments the hydrophobic silica is limited to being less than 0.1 weight percent based on the weight of the composition. The colloidal particulate can be hydrophobic and or hydrophilic fumed silica or other particles such as iron and other inorganic particulate materials. Specific examples of this type of component include Aerosil and Cabosil silicas from DeGussa and Cabot corporations. The amounts of colloidal particulate in the compositions of the present invention are desirably from about 1 to 50 weight percent, more desirably from about 2 to 10 weight percent, and preferably from about 2 to about 5 weight percent based on the weight of the formulation.

The colloidal particulate provides a particular type of viscosity modification to the mixture causing the resultant gel to exhibit non-Newtonian behavior. When sufficient colloidal material is present, the surfaces of adjacent particulate materials can hydrogen bond to adjacent particles forming a network that is resistant to stress. This provides thixotropic behavior, high yield stress values, and bleed resistance (anti-drip). Above a certain stress value these hydrogen bonds are broken and the gel deforms without memory of its previous shape and the hydrogen bonds between adjacent particles reform to re-establish a rigid network. Such behavior is generally not available from high molecular weight soluble polymers.

Coupling Agent(s)

Coupling agents are optional and function to couple the particulate material into a more continuous network building viscosity or modulus without adding more particulate material. Coupling agents generally are capable of hydrogen bonding with hydroxyl groups on the colloidal particulate material. Coupling agents with hydroxyl groups are preferred (e.g. bifunctional and polyfunctional alcohols). They can be monomeric, oligomeric, or polymeric. Specific examples of this type of component include polyglycols (including but not limited to poly (alkylene oxide) and other polyols.

The amounts of coupling agents are generally up to 2 or 5 weight percent, more desirably from about 0.1 to about 2, and preferably from about 0.1 to about 0.9, and preferably from about 0.1 to about 0.6 weight percent.

Other Optional Additives

Other additives include antioxidants, hydrogen absorbing agents, surfactants, antiwear (including EP) agents, and antifoam agents. These may or may not be necessary depending upon the particular application of the gel and transmission cable. Many oils can slowly oxidize over time. The antioxidants help increase oxidative induction time, ameliorate changes in the molecular weight of the oil and high molecular weight polymer, and reduce adverse color changes in the gel. Without them, depending on the resistance of the oil and polymer to oxidation, the oil and polymer might degrade into lower molecular weight components (possibly volatile), or higher molecular weight components (possibly sludge), and or a combination of lower and higher molecular weights (generating both more volatility and more sludge). The antifoam agents incorporated in the formulation can help reduce the inclusion of gas bubbles in the gel and reduce foaming above the surface of the gel.

The amounts of optional functional components in the compositions of the present invention are generally up to 5 weight percent, more desirably from about 0.1 to about 5 and preferably from about 0.1 to about 1 weight percent. The particular relationship between the amounts and types of the above components is by weight.

Recipe I: Synthetic Oil Based Recipe

| | | Quantity | |
|---|---|---|---|
| | | used for a | |
| | | 10 gallon | |
| Ingredient | Manufacturer | batch (lbs) | Wt. Percent |
| PAO-40 Mobil SHF4 | Mobil | 4.567 | 45.67% |
| (base oil) | | | |
| Polybutene H100 | Chemcentral | 2.855 | 28.55% |
| Polybutene H300 | Ciba | 2.093 | 20.93% |
| Irganox L135 | Ciba Gigy | 0.045 | 0.45% |
| (antioxidant) | | | |
| Aerosil 300VS - | Degussa | 0.400 | 4.00% |
| Hydrophilic Silica | | | |
| Polyglycol 2000 | Dow Chemical | 0.041 | 0.41% |
| (coupling agent) | | | |
| Total | | 10.00 | 100% |

The gels can be prepared by any method that disperses the silica and the other components uniformly in the oils. Such procedures are disclosed in the prior art. A preferred procedure is listed below.

Procedure

Mix the H100, H300 and SHF4 in a beaker on a hot plate at about 70-80C using a spatula or other mixing technique.

Transfer the mixed base oils to the 2 gallon unit and maintain at 75F (Stirring: 25 rpm anchor; 6800 rpm disperser; 5500 rpm emulsifier). An example of such a unit may be the Ross Versamix unit available from Ross, Happague, N.Y.

Mix for 5 minutes and turn off disperser and emulsifier (to prevent possible shearing of polybutene). Turn on Mokon heating unit to 110° F. Batch temp is about 110 F. Stir for 15 minutes. (Stirring; Anchor 50 rpm; disperse and emulsifier 0 rpm).

Pull a sample out for ASTMD445 viscosity at 100° C.

Sample looks white and frothy at this stage with a lot of air entrapped

Put Irganox L135 and Aerosil 300 VS and mix for 5 mins (Stirring: 22 rpm anchor; 4050 rpm disperser; 4500 rpm emulsifier). Temp is about 110F. due to mixing.

Stop stirring, lift mixer and clean mixer area and lid to remove solid silica.

Continue mixing for 10 mins (80 rpm anchor; 6450 rpm disperser; 0 rpm emulsifier)

Add polyglycol and mix 30 min ((80 rpm anchor; 6450 rpm disperser; 4500 rpm emulsifier).

Turn off stirring except anchor at 40 rpm. Pull vacuum till batch is clear. If necessary the mixture may be heated to >100° F. when the vacuum is applied. This can provide a thinner material that can degas more effectively.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. While ranges are given for most of the elements of the invention independent of the ranges for other elements, it is anticipated that in more preferred embodiments of the invention, the elements of the invention are to be combined with the various (assorted) desired or preferred ranges for each element of the invention in various combinations.

As used herein, the expression “consisting essentially of” permits the inclusion of substances that do not materially affect the basic and novel characteristics of the composition under consideration. Comprising means having at least the listed elements and optionally a variety of other unnamed elements that might affect the basic characteristics of the composition.

1. A non-newtonian jelly composition suitable for use in optical fiber cable manufacture comprising:
a. a synthetic oil of lubricating viscosity,
b. a fumed silica,
c. an antioxidant, and
d. a coupling agent.

2. The composition of claim 1 wherein the fumed silica is hydrophobic or hydrophilic.

3. The composition of claim 1 wherein the fumed silica is hydrophilic and the composition is substantially free of hydrophobic silica.

4. The composition of claim 1 wherein the fumed silica has an average primary particle size raging from 5-30 nm.

5. The composition of claim 1 wherein the fumed silica has an average specific BET surface of 150-400 m²/g.

6. The lubricating composition of claim 1 wherein the fumed silica is present from 1 to 10% by weight.

7. The composition of claim 1 wherein the fumed silica is present from 2-6% by weight.

8. The composition of claim 1 wherein the preferred synthetic oil is chosen from a group of polydecenes, polyisoprenes, polyisobutenes, and polybutenes.

9. The composition of claim 1 wherein the synthetic oil comprises at least 85% of the composition by weight.

10. The composition of claim 1 wherein the synthetic oil is a mixture of at least two oils chosen from the group of polydecenes and polybutenes.

11. The composition of claim 1 wherein the coupling agent is a chemical with at least one hydrogen bonding site.

12. The composition of claim 1 wherein the coupling agent is a polyglycol.

13. The composition of claim 12 wherein the polyglycol has a number average MW of at least 1000.

14. The composition on claim 1 comprising an antioxidant.

15. The lubricant composition of claim 1 wherein the antioxidant is a hindered phenol antioxidant.

16. The lubricant composition of claim 16 wherein the antioxidant is present from 0.1 to 2% by weight.

17. The composition of claim 1 wherein the synthetic oils are a mixture of polydecene and polybutene, the silica is hydrophilic and the coupling agent is a polyglycol.

18. The composition of claim 17 where the polybutene has a number average MW of less than 2000.

19. The composition of claim 17 wherein the preferred amount of polybutene used is at least 40% by weight of the total formulation.

20. The composition of claim 17 wherein the polyglycol has a number average molecular weight of 2000.

21. The composition of claim 17 where the preferred composition comprises a mixture of polydecene and polybutene in a ratio of 1:1.

22. The composition of claim 17 wherein the preferred composition comprises a hydrophilic silica with a surface area of at least 150 m²/g.

23. The composition of claim 17 wherein the hydrophilic silica has a surface area of greater that 250 m²/g.

24-33. (canceled)
